(19) United States
(12) Patent Application Publication
(10) Pub. No.: US 2009/0095906 A1
(43) Pub. Date: Apr. 16, 2009

(54) IMAGE CAPTURING

(75) Inventors: Anders GAVNER, Danderyd (SE); Martin GUNNARSSON, Stockholm (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/870,671

(22) Filed: Oct. 11, 2007

(51) Int. Cl. G01J 5/10; G01J 1/42

(52) U.S. Cl. 250/338.1; 250/393; 250/372; 250/395

(57) ABSTRACT

A portable electronic device comprising an image capturing unit adapted to capture at least one image of an object. Also, the portable electronic device may include at least one light emitting element adapted to emit infrared light. Further, the image capturing unit may reside within the portable electronic device and be configured to capture an image of the object illuminated with infrared light. The present invention provides a method for illuminating an object, a computer program product and an accessory unit to a portable electronic device.

### TECHNICAL FIELD

The present invention relates to the field of portable electronic devices and, more particularly, to a device and method for depicting an object in darkness when using a portable electronic device.

### BACKGROUND OF THE INVENTION

A portable electronic device may include a camera. Such portable electronic device comprising a camera may be able of performing a plurality of functions. For example, a portable electronic device comprising a camera may be used for taking pictures or for recording movies, thus substituting, for example, a digital still camera and/or a digital video camera.

A portable electronic device comprising a camera may also be adapted to communicate in a wireless communication network, such as a cellular mobile telephone with an in-built camera or even several cameras, for example, two cameras, of which one may be used for video telephony and one for normal image capturing.

Many users of such a portable electronic device may be interested in using the device for video telephony or photographing in various lighting conditions, for example, unfavorable lighting conditions at night time, in rain, dust and fog; or indoors, in shady bars, smoke filled clubs, obscure entertainment establishments, etc.

### Video Telephony in Darkness

A portable electronic device comprising a camera, such as a cellular mobile telephone with an in-built camera may be used for video telephony. There is, however, a problem to make a video telephony call if the calling person is situated in unfavorable lighting conditions, for example, at night time. Video telephony may be valuable in particular for hearing impaired or deaf people, who otherwise may not be able to perform a telephone call at all. A solution to that problem may be to provide the portable electronic device with a photo light, illuminating the calling person.

However such photo light may dazzle a user during the illuminated video telephony call. The user may experience the photo light as very disturbing and even painful for the eyes, which may lead to face distortion, ticks, and may release a stressed, tensed and spastic facial behavior in general.

A user of a portable electronic device may also want to initiate a video telephony connection or take a photo in a gloomy surrounding where photo light is not allowed, for example, in a museum, an illicit bar, etc. The user may also want to make a documentation of vandalism, theft, or altercations in a dark environment without revealing himself herself, as would be the result if a photo light, flash or lamp was used.

### Photographic Function in Darkness

In order to enhance picture quality when using the photographic function and enable use of, for example, the described camera features in poor light or darkness, an electronic flash unit, or an electronic photo light unit may be included within the portable electronic device.

However, the user of a portable electronic device may want to take a photo in a poorly lit surrounding where it is impracticable to use a photo light, as the photo light may disturb, temporarily blind, or dazzle the photo object. This may occur when taking a photo of, for example, a wild animal, a young child, a person driving a vehicle, a sleeping person, or a performer on stage.

The problems connected with using a photo light may be avoided simply by not using the photo light when taking pictures in darkness. However, such non use of a photo light when taking pictures in poor lighting conditions usually result in dark and grainy images, bringing a multitude of disappointment to the user.

Therefore, it is a problem with portable electronic devices comprising a camera to make them able of taking pictures or movies in poor lighting conditions in a way that satisfies the requirements of a user.

### Observing in Darkness

It may also be a problem to make an observation of something that occurs in darkness, without using a flashlight. In some situations use of a flashlight may be inappropriate. Such situation may occur, for example, when a user is trying to find a way to a seat in a dark cinema.

Thus it is a problem to use a portable electronic device for photographing, making an observation or making a video telephony call discretely, in a poorly lit environment.

### SUMMARY OF THE INVENTION

Implementations of the present invention aims obviate and/or reduce at least some of the above mentioned problems and provides an improved portable electronic device.

A first aspect of the present invention is directed towards a portable electronic device comprising an image capturing unit adapted to capture at least one image of an object. Also, the portable electronic device includes at least one light emitting element adapted to emit light with a wavelength outside the visible spectrum. Further, the image capturing unit included within the portable electronic device is adapted to capture an image of the object illuminated with light with a wavelength outside the visible spectrum.

A second aspect of the present invention includes the features of the first aspect, wherein the portable electronic device includes a control unit, which is adapted to activate the at least one light emitting element when the portable electronic device is set in an image capturing mode.

A third aspect of the present invention includes the features of the second aspect, wherein the portable electronic device includes a communication unit adapted to establish a video telephony connection with a recipient of a video telephony call. Also, the control unit is adapted to activate the at least one light emitting element continuously, as long as the portable electronic device is set in an image capturing mode.

A fourth aspect of the present invention includes the features of the second aspect, wherein the portable electronic device includes a light sensor, adapted to measure light related data indicating the strength of the incoming light. Also, the portable electronic device includes at least one light emitting element adapted to receive a control signal from the control unit. Further, the portable electronic device includes a control unit adapted to receive light related data indicating the strength of the incoming light and comparing it with a predetermined threshold value. The control unit is also adapted to determine when to activate and when to deactivate the at least one light emitting element based on said light related data, and to send control information to the at least one light emitting element for activating or deactivating the at least one light emitting element.

A fifth aspect of the present invention includes the features of the fourth aspect, wherein the control unit is adapted to determine the strength of the light that the at least one light emitting element has to emit in order to enlighten an object based on said light related data. The control unit is also adapted to send control information to the at least one light emitting element for adjusting the strength of the light emitted from the at least one light emitting element.

A sixth aspect of the present invention includes the features of the first aspect, wherein the portable electronic device includes a viewfinder, adapted to display the object illuminated by the at least one light emitting element.

A seventh aspect of the present invention includes the features of the first aspect, wherein the portable electronic device includes a lens situated in front of at least one of the at least one light emitting elements.

An eighth aspect of the present invention includes the features of the seventh aspect wherein the lens is adapted to focus the emitted infrared light on a distance of about 0.2 to about 0.5 meters.

A ninth aspect of the present invention includes the features of the first aspect wherein at least one light emitting element is adapted to emit infrared light, with a wavelength of about 750 nm to about 1 mm.

A tenth aspect of the present invention includes the features of the first aspect wherein at least one light emitting element is adapted to emit ultraviolet light with a wavelength of about 10 nm and about 400 nm.

An eleventh aspect of the present invention includes the features of the first aspect wherein the portable electronic device is represented by a portable communication device such as a mobile cellular radio telephone.

A twelfth aspect of the present invention is directed towards a method for visualization of an object in darkness by using a portable electronic device. The portable electronic device includes an image capturing unit and at least one light emitting element. The method for visualization of an object in darkness further includes activating an image capturing function and receiving a darkness indication. Further, the method include emitting light with a wavelength outside the visible spectrum, such that the intended photo object is illuminated with light with a wavelength outside the visible spectrum, if a darkness indication is received and an image capturing function is activated.

A thirteenth aspect of the present invention includes the features of the twelfth aspect, wherein the method for visualization of an object in darkness further includes measuring light related data, indicating the strength of the incoming light and comparing the measured light related data with a predetermined threshold value. Based on this comparison, the method further includes determining when to activate and when to deactivate the at least one light emitting element based on said light related data. Such method also includes generating control information, for activating or deactivating the at least one light emitting element and sending the generated control information to the at least one light emitting element for activating the at least one light emitting element if the measured light related data is lower than a certain predetermined threshold value. Alternatively, the method includes deactivating the at least one light emitting element if the measured light related data is higher than a certain predetermined threshold value and the image capturing unit is still activated.

A fourteenth aspect of the present invention is directed towards a computer program product comprising computer-readable program code embodied on a computer-readable medium, the computer readable program code being conFig.d to carry out the method according to the twelfth aspect of the present invention.

A fifteenth aspect of the present invention is directed towards an accessory to a portable electronic device which includes an image capturing unit, wherein the accessory includes a connection unit adapted to send and/or receive control signals from the portable electronic device. Further, the accessory includes at least one light emitting element adapted to emit light with a wavelength outside the visible spectrum if a darkness indication is received and the portable electronic device is set in an image capture mode.

A sixteenth aspect of the present invention includes the features of the fifteenth aspect, wherein the accessory includes a light sensor, adapted to measure light related data indicating the strength of the incoming light. The light sensor is adapted to send said light related data to a control unit. The accessory also includes at least one light emitting element adapted to receive a control signal from the control unit. The control unit is adapted to determine when to activate and when to deactivate the at least one light emitting element based on said light related data, and to send control information to the at least one light emitting element for activating or deactivating the at least one light emitting element.

An seventeenth aspect of the present invention includes the features of the fifteenth aspect, wherein the accessory includes a lens situated in front of at least one of the at least one light emitting element.

An eighteenth aspect of the present invention includes the features of the seventeenth aspect, wherein the lens is adapted to focus the emitted infrared light on a distance of about 0.2 to about 0.5 meters.

A nineteenth aspect of the present invention includes the features of the fifteenth aspect, wherein at least one light emitting element is adapted to emit infrared light, with a wavelength of about 750 nm to about 1 mm.

A twentieth aspect of the present invention includes the features of the fifteenth aspect, wherein at least one light emitting element is adapted to emit ultraviolet light with a wavelength of about 10 nm and about 400 nm.

A twenty-first aspect of the present invention includes the features of the fifteenth aspect, wherein the accessory is adapted to be attached to a portable communication device such as a mobile cellular radio telephone.

Since the light emitting elements included within the portable electronic device or the accessory to a portable electronic device according to the invention, are adapted to emit light with a wavelength outside the visible spectrum, such as infrared light and/or ultraviolet light, the image detection unit/units within the portable electronic device are adapted to detect and interpret reflections from infrared and/or ultraviolet light and display an image to a user, an object could be viewed, photographed, filmed or video telephoned in darkness, without emitting visible light. Thus it is possible to make a video telephone call in a dark surrounding without harassing the users eyes with a disturbing sharp white light. An advantage of the present device, method, computer program and accessory is that a photo or video sequence could be taken in a poorly lit surrounding where it is inappropriate to use a photo light.

An advantage of the present device, method, computer program and accessory is that an observation of something that occurs in darkness could be made without using a flashlight, which might be inappropriate or disturbing for other people in some situations and/or without destroying the night vision of a user.

### BRIEF DESCRIPTION OF THE DRAWINGS

The present invention will now be described more in detail in relation to the enclosed drawings, in which:

FIG. 1 is a schematic illustration over an embodiment of a portable electronic device comprising a light emitting element;

FIG. 2 schematically depicts an embodiment of a portable electronic device comprising an image capturing unit and a light emitting element;

FIG. 3 is a flow chart illustrating a method in a portable electronic device or in an accessory for illumination of an object with light with a wavelength outside the visible spectrum; and

FIG. 4 is schematically illustrating an embodiment of a system with a portable electronic device and an accessory, arranged to be attached to the portable electronic device and to illuminate an object with light with a wavelength outside the visible spectrum.

### DETAILED DESCRIPTION OF PREFERRED EMBODIMENTS

The invention is defined as a portable electronic device, a method, a computer program and an accessory which may be put into practice in the embodiments described below.

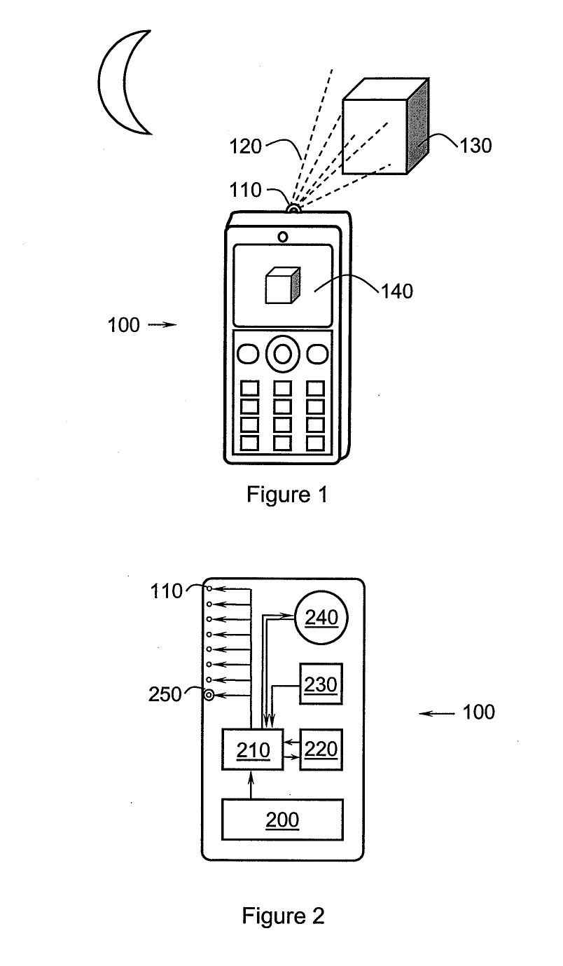

FIG. 1 is a schematic illustration over an embodiment of a portable electronic device 100 in unfavorable lighting conditions, such as darkness.

The portable electronic device 100 as herein described may in an embodiment include a mobile station such as a mobile cellular radiotelephone. The portable electronic device 100 may however in an embodiment include a digital enhanced cordless telecommunications (DECT) telephone, a personal digital assistant (PDA), a laptop, a computer, a digital still camera, a digital video camera or any other kind of portable electronic device, such as a notebook computer, walkie-talkie, hunting radio, baby monitor, etc. The portable electronic device 100 may in one embodiment be a foldable portable electronic device such as a clam shell or foldable knife type cellular phone, for example, Sony Ericsson W300i.

The portable electronic device 100 includes an image capturing unit and a light emitting element 110. According to some embodiments, the portable electronic device 100 may include a plurality of light emitting elements 110, for example, between 2 and 20 light emitting elements 110. According to some embodiments, the portable electronic device 100 may include more than 20 light emitting elements 110. The portable electronic device 100 may in some embodiments include a plurality of image capturing units, for example, two image capturing units.

The light emitting element 110 may be a Light emitting Diode (LED), an incandescent light bulb, an electric lamp, an arc lamp, a fluorescent light, a high-intensity discharge lamp, a xenon light, a halogen lamp, flashes or any other convenient source capable of emitting photons, thus creating an artificial light out of the visible spectrum. The light emitting element 110 may include light emitting elements 110 of the same type or of different types, for example, LEDs emitting light waves with different wavelength. The light emitting element 110 is in particular adapted to emit light 120 with a wavelength outside the visible spectrum. Light with a wavelength outside of the visible spectrum may be infrared light or ultraviolet light. In some embodiments, the light emitting element 110 is adapted to emit infrared light 120 with a wavelength of about 750 nm to about 1 mm. In some embodiments, the light emitting element 110 is adapted to emit ultraviolet light 120 with a wavelength of about 10 nm to about 400 nm. Different light emitting elements 110 included within the portable electronic device 100 may be adapted to emit light 120 with a wavelength outside of the visible spectrum with different wavelength, such as infrared light and ultraviolet light. Further, according to some embodiments, the portable electronic device 100 may include some light emitting elements 110 adapted to emit infrared light and some light emitting elements 110 adapted to emit ultraviolet light and/or light within the visible spectrum. According to some embodiments, the portable electronic device 100 may include light emitting elements 110 adapted to adjust the wave length of the emitted light, such that the user may switch between letting the light emitting elements 110 emit infrared light and ultraviolet light and/or light within the visible spectrum.

An advantage of using LED as light emitting elements 110 for emitting light 120 with a wavelength outside the visible spectrum may be that they are cheap, consume a modest amount of power, they are robust in comparison with at least some other light emitting elements 110. Also, LEDs in general have a relatively long burning time. The fact that a LED flash operates from a low voltage supply is also important, since this may reduce the space required for implementation.

Light 120 with a wavelength outside the visible spectrum, such as infrared light or ultraviolet light is in reality invisible for the human eye, but in order to facilitate the understanding of the invention, light beams 120 are schematically depicted in FIG. 1.

The portable electronic device 100 may be directed towards an arbitrary object 130 or a plurality of disparate objects. The light 120 with a wavelength outside the visible spectrum is reflected against the surface of the object 130, which reflections may be detected by the image capturing unit included within the portable electronic device 100.

The image capturing unit according to the invented solution is, unlike the human eye, adapted to detect objects 130 illuminated only with infrared light or ultraviolet light. The image capturing unit may therefore detect the received infrared and/or ultraviolet light reflections of the object 130 and interpret the reflections such that a photographic image may be generated by the image capturing unit, depicting the object 130. Thus a photographic image of the object 130, visible for a human eye, may be created and displayed for a user.

The image capturing unit according to the invented solution may also detect and interpret the reflections of the object 130 and send signals to a viewfinder 140 included within the portable electronic device 100 such that the viewfinder 140 may display an image of the object 130, which image is visible for a human eye.

The viewfinder 140 may be a charge-coupled device (CCD), a CMOS sensor, an active pixel sensor or similar.

FIG. 2 schematically depicts an embodiment of a portable electronic device 100 comprising an image capturing unit 240 and a plurality of light emitting elements 110. The light emitting elements 110 are adapted to emit light with a wavelength outside the visible spectrum 120, such as infrared light and/or ultraviolet light. The image capturing unit 240 is adapted to capture an image of the object 130 illuminated with infrared light and/or ultraviolet light.

The image capturing unit 240 may in some embodiments be adapted to capture a continuous flow of images, represented by, for example, a video, film, movie, etc. The control unit 210 may in some embodiments be adapted to activate the at least one light emitting element 110 continuously, as long as the portable electronic device 100 is set in an image capturing mode.

The portable electronic device 100 may according to some embodiments include a plurality of image capturing units 240. In some embodiments, the portable electronic device 100 may include a first image capturing unit 240 placed on a first side of the portable electronic device 100, and a second image capturing unit 240 placed on a second side of the portable electronic device 100. The first and the second sides of the portable electronic device 100 may be situated on opposite sides of each other, according to some embodiments. Further, the first image capturing unit 240 may be adapted to be used for video telephony and the second image capturing unit 240 may be adapted for photography and/or video recording.

The portable electronic device 100 further includes a control unit 210, which may be adapted to activate the light emitting elements 110 when the portable electronic device 100 is set in an image capturing mode. Thus the light emitting element 110 may be adapted to receive control signals from the control unit 210.

The control unit 210 may be a central processing unit (CPU), a microprocessor, a peripheral interface controller (PIC) microcontroller or any other appropriate device adapted to interpret computer program instructions and processes data.

The light emitting elements 110 may however in some embodiments be activated when the user makes a darkness indication, for example, by pressing a darkness indication button. The light emitting elements 110 may in some embodiments be activated when the user makes a darkness indication, for example, by selecting a black light mode choice on the viewfinder 140.

The portable electronic device 100 may according to some embodiments include a light sensor 230, adapted to measure light related data indicating the strength of the incoming light. Further, the control unit 210 may be adapted to receive light related data indicating the strength of the incoming light and comparing it with a predetermined threshold value. The predetermined threshold value may be previously stored in a memory unit 220, included within the portable electronic device 100. The predetermined threshold value represents a value when the image capturing device 240 needs extra light in order to properly capture an image of an object 130.

The memory unit 220 may be a primary storage memory unit such as a processor register, a cache memory, a random access memory (RAM) or other storage device. The memory unit 220 may, however, in some embodiments, be a secondary memory unit such as a read only memory (ROM), electrically erasable programmable read-only memory (EEPROM), programmable read-only memory (PROM) or erasable programmable read only memory (EPROM) or a hard disk drive. The memory unit 220 may however in some embodiments be an off-line storage memory unit, a flash memory, a USB memory or a memory card. The memory unit 220 may in some embodiments be a network-attached storage (NAS) or in fact any other appropriate medium such as a disk or a tape that can hold machine readable data.

The light emitting element 110 may further be adapted to receive a control signal from the control unit 210, according to some embodiments.

The control unit 210 may according to some embodiments be adapted to determine when to activate and when to deactivate the at least one light emitting element 110 based on the light related data. Also, the control unit 210 may send control information to the light emitting element 110 for activating or deactivating the light emitting element 110.

Thus, when the control unit 210 sends an activation control signal, the light emitting element 110 may emit infrared light and/or ultraviolet light. Also, the opposite situation may occur. When the control unit 210 sends a deactivation control signal, the light emitting element 110 may terminate emitting infrared light and/or ultraviolet light.

An advantage with these embodiments is that the light emitting elements 110 may be activated automatically, without requiring further effort from the user.

Further, the control unit 210 may, in some embodiments, be adapted to determine the strength of the light that the at least one light emitting element 110 has to emit to illuminate the object 130 based on said light related data. The control unit 210 may, according to some embodiments, also send control information to the at least one light emitting element 110 for adjusting the strength of the light 120 emitted from the at least one light emitting element 110.

An advantage with these embodiments is that energy may be saved so that the battery of the portable electronic device 100 may be reloaded less frequently.

The portable electronic device 100 may according to some embodiments include a communication unit 200 adapted to establish a video telephony connection with a recipient of a video telephony call. The communication unit 200 may be adapted to communicate the captured mages within a wireless communication system to a recipient. The communication unit 200 may be adapted to communicate, for example, in code divisional multiple access (CDMA), wideband code division multiple access (WCDMA), cdma2000, high speed packet data access (HSPA), high speed downlink packet data access (HSDPA), fraction high speed downlink packet data access (F-HSDPA), high speed uplink packet data access (HSUPA), universal mobile telecommunications system (UMTS), long term evolution (LTE), or according to any other wireless communication standard.

The communication unit 200 may be adapted to send an image or a continuous flow of images, represented by, for example, a video, film, movie, etc. to the recipient of the video telephony call. The images may display an object 130 illuminated with infrared light and/or ultraviolet light 120 emitted from a light emitting element 110, such that the recipient of the video telephony call may receive an image representing the object 130, visible for a human eye.

The portable electronic device 100 may in some embodiments include a viewfinder 140, which may be adapted to display the object 130 illuminated by the at least one light emitting element 110, as previously explained. Thus, the portable electronic device 100 may be used as a black flashlight when the portable electronic device 100 is set to a viewfinder mode.

When the portable electronic device 100 is set to a viewfinder mode, observations may be made in darkness without disturbing the surrounding and/or without destroying the night vision of a user.

An advantage of some of the embodiments is that an observation of something that occurs in darkness may be made, without using a flashlight. This may be of particular advantage in situations where the usage of a flashlight may be inappropriate, for example, when a user is trying to find her/his way to the seat in a dark cinema.

According to some embodiments, the portable electronic device 100 may include a lens 250 situated in front of at least one of the at least one light emitting elements 110. Thus the infrared light and/or ultraviolet light 120 may be focused on a certain predetermined distance. For some light emitting elements 110, in particular for light emitting elements 110 intended to be used for video telephony, the lens 250 may be adapted to focus the emitted infrared light and/or ultraviolet light 120 on a distance of about 0.2 to about 0.5 meters, e.g., arms' length distance. For some other light emitting elements 110, which may be intended to be used for photography or video recording, the lens 250 may be adapted to focus the emitted infrared light and/or ultraviolet light 120 on a distance of about 0.5 to about 20 meters, for example, on a distance of between 1 to 2 meters. According to some embodiments, different light emitting elements 110 may have a lens 250, which may be adapted to focus the emitted infrared light and/or ultraviolet light 120 on different distances, for example, one light emitting element 110 may have a lens 250 adapted to focus the emitted infrared light and/or ultraviolet light 120 on a distance of 0.5 meter, another light emitting element 110 may have a lens 250 adapted to focus the emitted infrared light and/or ultraviolet light 120 on a distance of 1 meter, yet another light emitting element 110 may have a lens 250 adapted to focus the emitted infrared light and or ultraviolet light 120 on a distance of 1.5 meter, etc.

As previously mentioned, the portable electronic device 100 in some embodiments may include a plurality of image capturing devices 240, for example, one camera adapted for video telephony on a first side of the portable electronic device 100 and one camera adapted to take pictures and/or video recordings on a second side of the portable electronic device 100. According to some embodiments, light emitting elements 110 may be situated on two different sides of the portable electronic device 100, for example, on two opposite sides. According to some embodiments, at least one light emitting element 110, for example, approximately 1-4 light emitting elements 110, adapted for video telephony may be placed on the first side of the portable electronic device 100, which first side also include a camera adapted for video telephony. On the second side of the portable electronic device 100, at least one light emitting element 110, for example, approximately 1-10 light emitting elements 110, adapted for illumination of a photo and/or video recording may be situated.

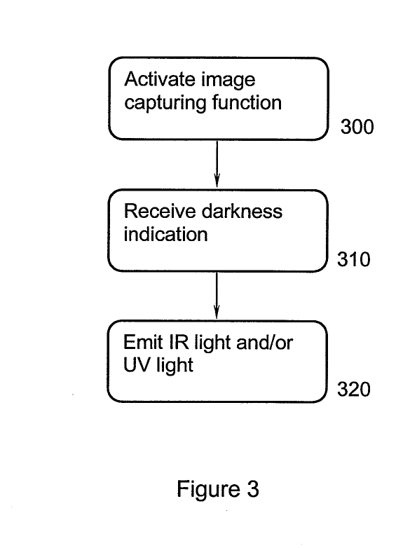

FIG. 3 is a flow chart illustrating a method in a portable electronic device 100 for visualization of an object 130 in darkness by illumination with light 120 with a wavelength outside the visible spectrum. The method concerns the use of a portable electronic device 100 comprising an image capturing unit 240 and at least one light emitting element 110. The method may include the following.

### Step 300

The portable electronic device 100 activates an image capturing function, for example, camera functionality or video telephony functionality. This activation may be made by the user manually by indicating that the portable electronic device 100 should be put in an image capturing mode or video telephony mode. The activation of an image capturing function may in some embodiments also be made automatically, for example, upon detection of a noise level exceeding a certain predetermined threshold value, or by the trigger from a movement detector. This may be an advantage, in particular when the portable electronic device 100 is set to surveillance mode.

### Step 310

The control unit 210 may be adapted to receive light related data indicating the strength of the incoming light, for example, a darkness indication and comparing it with a predetermined threshold value. Light related data indicating the strength of the incoming light, may be measured by a sensor 230 included within the portable electronic device 100, for example, a light sensor measuring the light conditions. The predetermined threshold value may be previously stored in a memory unit 220, included within the portable electronic device 100. The predetermined threshold value represents a value when the image capturing device 240 needs extra light in order to properly capture an image of an object 130. The control unit 210 may be adapted to determine when to activate and when to deactivate the at least one light emitting element 110 based on said light related data, and to generate control information, for activating or deactivating the at least one light emitting element 110. Thus control information to the at least one light emitting element 110 is generated for activating the at least one light emitting element 110 if the measured light related data is lower than a certain predetermined threshold value, or deactivating the at least one light emitting element 110 if the measured light related data is higher than a certain predetermined threshold value and the image capturing unit 240 is still activated.

The darkness indication may however be made manually by a user, for example, by pressing a button on the portable electronic device 100.

### Step 320

If a darkness indication is received and an image capturing function is activated, a control signal for activating the light emitting element 110 is sent from the control unit 210 to the light emitting element 110, such that the intended photo object 130 is illuminated with light 120 with a wavelength outside the visible spectrum.

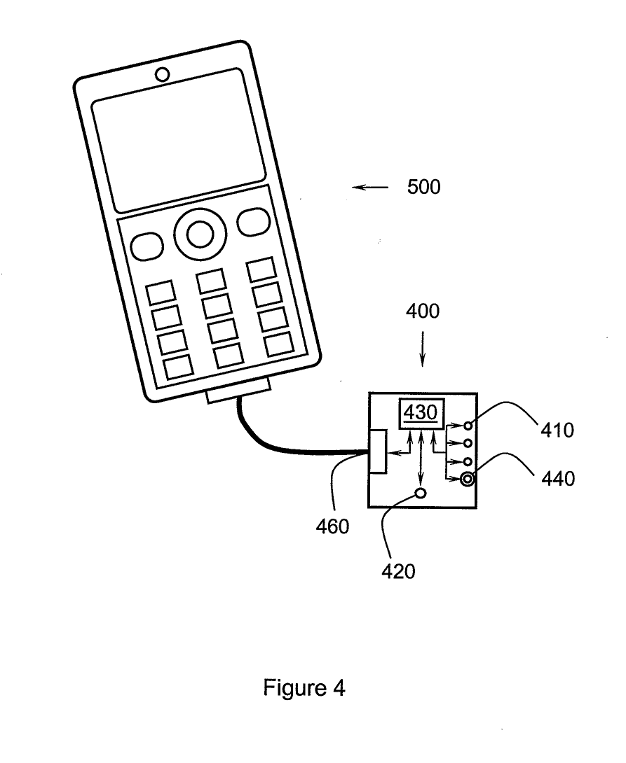

The method for creating visualization of an object 130 in darkness by illumination with light 120 with a wavelength outside the visible spectrum by using a portable electronic device 100 according to the present method can be implemented through one or more processors, such as the processor unit 210 in the portable communication device 100 depicted in FIG. 2 and the processor unit 430 in the adaptor unit 400 depicted in FIG. 4, together with computer program code for performing the functions of the method. The program code mentioned above may also be provided as a computer program product, for instance in the form of a data carrier carrying computer program code for performing the method according to the present invention when being loaded into a processor unit 210 and/or 430. The data carrier may be a CD ROM disc, a memory stick, or any other appropriate medium such as a disk or tape that can hold machine readable data. The computer program code can furthermore be provided as pure program code on a server and downloaded to the portable communication device 100 and/or adaptor unit 400 remotely.

Thus a computer program comprising instruction sets for performing the method according to steps 300-320 may be used for implementing the previously described method.

This may be performed in form of a computer program product comprising computer-readable program code embodied on a computer-readable medium, the computer readable program code being configured to carry out the method according to steps 300-320.

FIG. 4 is schematically illustrating an embodiment of a system with a portable electronic device 500 and an accessory 400, arranged to be attached to the portable electronic device 500 and to illuminate an object 130 with light 120 with a wavelength outside the visible spectrum, such as infrared light and/or ultraviolet light.

There may emerge a need of a portable electronic device 500 adapted to emit light 120 with a wavelength outside the visible spectrum and to capture an image of the object 130 illuminated with infrared light and/or ultraviolet light, also among users of portable electronic devices 500 not being adapted to emit infrared light and/or ultraviolet light. Such desire may be satisfied by providing an accessory 400, the accessory 400 is arranged to be attached to a portable electronic device 500. Such an accessory 500 adapted to be attached to a portable electronic device 500 is depicted in FIG. 4.

The portable electronic device 500 as herein described may in an embodiment include a mobile station such as a mobile cellular radiotelephone. The portable electronic device 500 may however in an embodiment include a personal digital assistant (PDA), a laptop, a computer, a digital still camera, a digital video camera or any other kind of portable electronic device, such as a notebook computer, walkie-talkie, hunting radio, baby monitor, etc. The portable electronic device 500 may in one embodiment be a foldable portable electronic device such as a clam shell or foldable knife type cellular phone, for example, Sony Ericsson W300i. However, the portable electronic device 500 includes an image capturing unit.

The connection between the accessory 400 and the portable electronic device 500 may be made through, for example, a fast port connector. According to some embodiments, the accessory 400 is connected directly to the fast port connector of the portable electronic device 500. According to some embodiments, the accessory 400 is connected via a cable to the fast port connector of the portable electronic device 500. According to some embodiments, the accessory 400 is connected via a Bluetooth® connection to the portable electronic device 500. According to some embodiments, the accessory 400 is connected via an infrared port to the portable electronic device 500.

However, the attachment may alternatively be made, for example, by snapping, sticking, pinning, bolting, pinching, strapping, clipping, pegging, screwing, hooking, hinging, taping, stitching, fastening, tacking, tying, cramping, gluing, velcroing, or in any other convenient way, permanently or temporarily attaching the portable electronic device 500 into the accessory 400. The accessory 400 and a portable electronic device 500 may thus form a system for visualization of an object 130 in darkness.

The accessory 400 may in an embodiment be produced in a plastic material i.e., a synthetic or semi synthetic polymerization material, for example, polyvinyl chloride, polyethylene, polymethyl, methacrylate, acrylics, silicones, polyurethanes, polypropylene, polystyrene, etc. However, the accessory 400 may as well be produced in, for example, metal, wood, rubber or any other convenient material.

The accessory 400 may be arranged to be attached as an adaptor to a portable electronic device 500 which portable electronic device 500 include an image capturing unit 240.

The accessory 400 may, in some embodiments, include a connection unit 460 adapted to send and/or receive control signals from the portable electronic device 500.

Also, the accessory 400 may in some embodiments include at least one light emitting element 410 adapted to emit infrared light and/or ultraviolet light if a darkness indication is received and the portable electronic device 500 is set in an image capture mode. According to some embodiments, the accessory 400 may include a plurality of light emitting elements 410, for example, between 2 and 20 light emitting elements 410.

The light emitting element 410 may be a light emitting diode (LED), an incandescent light bulb, an electric lamp, an arc lamp, a fluorescent light, a high-intensity discharge lamp, a xenon light, a halogen lamp, flashes or any other convenient source capable of emitting photons, thus creating an artificial light out of the visible spectrum. The light emitting element 410 may include light emitting elements 410 of the same type or of different types, for example, LEDs emitting light waves with different wavelength. The light emitting element 410 is in particular adapted to emit infrared light 120. In some embodiments, the light emitting element 110 is adapted to emit infrared light 120 with a wavelength of about 750 nm to about 1 mm. Different light emitting elements 410 included within the accessory 400 may be adapted to emit infrared light 120 with different wavelength. Further, according to some embodiments, the accessory 400 may include same light emitting elements 410 adapted to emit infrared light 120 and some light emitting elements 410 adapted to emit ultraviolet light and/or light within the visible spectrum.

Further, according to some embodiments, the accessory 400 may include a light sensor 420, adapted to measure light related data indicating the strength of the incoming light, said light sensor 420, being further adapted to send said light related data to a control unit 430. The control unit 430 may in some embodiments be included in the portable electronic device 500.

The at least one light emitting element 410, included within the accessory 400 may in some embodiments be adapted to receive a control signal from the control unit 430. The control unit 430 may according to some embodiments be adapted to determine when to activate and when to deactivate the at least one light emitting element 410 included within the accessory 400. Such determination may be based on said light related data. The control unit 430 may according to some embodiments be adapted to send control information to the at least one light emitting element 410 for activating or deactivating the at least one light emitting element 410.

According to some embodiments, the accessory 400 may include a lens 440 situated in front of at least one of the at least one light emitting elements 410. Thus the infrared light and/or ultraviolet light 120 may be focused on a certain predetermined distance. For some light emitting elements 410, in particular for light emitting elements 410 intended to be used for video telephony, the lens 440 may be adapted to focus the emitted infrared light and/or ultraviolet light 120 on a distance of approximately 0.2-0.5 meters, i.e. arm length distance. For some other light emitting elements 410, which may be intended to be used for photography or video recording, the lens 440 may be adapted to focus the emitted light 120 on a distance of about 0.5 to about 20 meters, for example, on a distance of between 1-2 meters. According to some embodiments, different light emitting elements 410 may have a lens 440, which may be adapted to focus the emitted light 120 on different distances, for example, one light emitting element 410 may have a lens 440 adapted to focus the emitted infrared light and/or ultraviolet light 120 on a distance of 0.5 meter, another light emitting element 410 may have a lens 440 adapted to focus the emitted infrared light and/or ultraviolet light 120 on a distance of 1 meter, yet another light-emitting element 410 may have a lens 440 adapted to focus the emitted infrared light and/or ultraviolet light 120 on a distance of 1.5 meter, etc.

According to some embodiments of the accessory 400 comprising a plurality of light emitting elements 410, these may be situated on two different sides of the accessory 400, for example, on two opposite sides of the accessory 400.

According to some embodiments, at least one light emitting element 410, for example, approximately 1-4 light emitting elements 410, adapted for video telephony may be placed on the first side of the accessory 400. On the second side of the accessory 400, at least one light emitting element 410, for example, approximately 1-10 light emitting elements 410, adapted for illumination of a photo and/or video recording may be situated.

In some embodiments, the accessory 400 have at least one light emitting element 410 placed on one side of the accessory 400. According to some embodiments, the accessory 400 is arranged to be turned in the direction where infrared light and/or ultraviolet light 120 is desired, for example, towards the user when the user is performing a video telephony call and/or directed towards an object 130 when the user intends to take a photographic image or record a film.

According to some embodiments, as previously described, the accessory 400 may be connected via a wireless connection to the portable electronic device 500, such as, for example, a Bluetooth® connection, infrared port, or other connection. Thus it may, according to some embodiments, be possible to use a plurality of accessories 400 to serve one portable electronic device 500. These accessories 400 may be placed in a plurality of locations on different distances from the portable electronic device 500 to cover a larger area with infrared light and/or ultraviolet light 120; and/or to intensify the illumination of a selected object 130.

An advantage with using a Bluetooth connection is that the accessory may be placed closer to the object 130 than the portable electronic device 500. Thus the light-emitting elements 410 included within the accessory does not have to emit as much infrared light and/or ultraviolet light 120 as otherwise would be needed to properly illuminate the object 130. Energy sources thus may be saved.

The portable electronic device 100 or the accessory 400 may according to some embodiments be used, for example, by a hunter making observations of a game animal in insufficient light conditions, when the portable electronic device 100 or the accessory 400 is set to a viewfinder mode. The emitted light may in some embodiments be within the infrared spectrum. In some embodiments, the portable electronic device 100 or the accessory 400 may be adapted to be mounted on the telescopic sight of a rifle or on a binocular. According to some of these embodiments, the portable electronic device 100 or the portable electronic device 500 may be represented by a hunting radio.

An advantage of such embodiments is that a detection and identification of a game animal in unfavorable light conditions may be made without alarming the animal.

Thanks to its infrared capabilities, the portable electronic device 100 and/or accessory 400 may capture evidence or images which is not seen by the human eye and functions in both the visible and infrared light spectrums. For example, the infrared capabilities may be helpful to find, for example, blood stain, which may be of great value when tracing a wounded animal in a hunting situation; or looking for evidence in a police investigation, etc.

When the present portable electronic device 100 and/or accessory 400 is used for emitting light within the ultraviolet spectrum, blood, urine and other secretions of some animals may be spotted more easily, which may lead to an easier animal tracking. Forensic scientists may also use the portable electronic device 100 and/or accessory 400 to capture evidence at crime scenes to find blood, urine, or semen, all fluorescent in ultraviolet light.

Further, certain flowers, fruits, insects and dangerous animals, for example, scorpions become fluorescent in ultraviolet light. The portable electronic device 100 and/or accessory 400 may be used for emitting light within the ultraviolet spectrum for detecting such flowers, fruits, insects and dangerous animals, for example, scorpions. Thus the danger of triggering a scorpion attack in poor light conditions may be reduced.

The portable electronic device 100 or the accessory 400 may, according to some embodiments, be used, for example, as a sight aid in poor lightning conditions, for example, for visually impaired, weak-sighted, elderly people, disabled or for people with reduced night vision, etc. This may be the case in particular when the portable electronic device 100 or the accessory 400 is set to a viewfinder mode.

When the portable electronic device 100 or the accessory 400 is set to a viewfinder mode, observations may be made in darkness without disturbing the surrounding and/or without destroying the night vision of a user.

An advantage of having the described sight aid available on a portable electronic device 100 or the accessory 400 is that most users of a portable electronic device 100 or the accessory 400 always, or at least rather frequently, carry the portable electronic device 100 or the accessory 400 with them. Thus a sight aid within the portable electronic device 100 or the accessory 400 may often be easily accessible to the user.

The portable electronic device 100 or the accessory 400 may according to some embodiments be used, for example, as a tool for inspecting battery status of an electronic device capable of emitting infrared light 120, such as, for example, a remote control or a device comprising an infrared port. When using the portable electronic device 100 or the accessory 400 for inspecting the battery status, the remote control is firstly activated and directed in line of sight from the portable electronic device 100 or the accessory 400. When the portable electronic device 100 or the accessory 400 is set, for example, to a viewfinder mode, it may be directed towards the activated remote control. The portable electronic device 100 or the accessory 400 will detect any emitted infrared light and may display it in the viewfinder 140. If the remote control emits infrared light, the battery is OK and the remote control appears to function properly. Otherwise, the battery of the remote control may be spent or the remote control may be inoperable for some other reason.

The portable electronic device 100 or the accessory 400 may according to some embodiments be used, for example, as a device for surveillance, in particular adapted for discrete surveillance in insufficient light conditions. When the portable electronic device 100 or the accessory 400 according to these embodiments is set to a surveillance mode, the image capturing function and/or video telephony function of the portable electronic device 100 or the accessory 400 may be activated upon the detection of a sound above a certain predetermined threshold level. In some embodiments, the image capturing function and/or video telephony function of the portable electronic device 100 or the accessory 400 may be activated with a regular time interval, for example, every hour. According to some embodiments, the image capturing function and/or video telephony function of the portable electronic device 100 or the accessory 400 may be activated upon request from a user when the portable electronic device 100 or the accessory 400 receive an activation signal from another portable electronic device 100 or the accessory 400, for example, in form of an short message service (SMS) message. In some embodiments, the image capturing function and/or video telephony function of the portable electronic device 100 or the accessory 400 may be activated when an activation signal is received from a movement sensor.

Thus a discrete surveillance in darkness may be made. This may be an advantage, for example, for parents who want to watch their baby while they temporarily leave the home for a visit at a restaurant, etc. The portable electronic device 100 or the accessory 400 according to these embodiments may also be used as a silent burglar alarm. Due to the high portability of the portable electronic device 100 or the accessory 400, the use of the portable electronic device 100 or the accessory 400 in surveillance mode may be an advantage in particular for a traveling user, for example, for surveillance of a hotel room, or for surveillance of a vehicle, for example, a car.

The portable electronic device 100 or the accessory 400 may, according to some embodiments, include light emitting elements 110 for emitting light within the ultraviolet spectrum also be used for combating counterfeiters of certain sensitive documents such as, for example, bank notes, credit cards, driver's licenses, passports, etc. These documents may include inter alia a UV watermark that can only be seen when viewed under a UV-emitting light. Currencies of various countries' banknotes may have an image, text, letter, national symbol or pattern or similar, which is visible only under ultraviolet light.

The present portable electronic device 100 or accessory 400 may with advantage be used as a portable document verification device, which may be useful in particular when traveling to foreign nations where the user is less familiar with the appearance of the local bank notes.

Organic material, chemicals and many other substances are fluorescent and lights up with UV-light.

Thus the portable electronic device 100 or the accessory 400 may, according to some embodiments, include light emitting elements 110 for emitting light within the ultraviolet spectrum also be used for inspection of cleaning and hygiene in production equipment, production premises, toilettes, sports centers, hospitals, etc. This may be an advantage in particular for a user who is traveling and want to instantly monitor the hygienic standard, for example, the bath room of a hotel room.

As ultraviolet light discourages and prohibits growth of mold, spores, algae, bacteria, germs, viruses and other organisms and micro organisms and allergens, the portable electronic device 100 or the accessory 400 may, according to some embodiments, include light emitting elements 110 for emitting light within the ultraviolet spectrum also be used for sterilization. According to some embodiments, ultraviolet light with a wavelength of about 10 nm to about 280 nm may be used with particular advantage for sterilization purposes.

The use of the portable electronic device 100 or the accessory 400 for sterilization purposes may be of particular advantage for the traveling user who wants to, for example, sterilize a tooth brush which has been dropped on the floor.

The portable electronic device 100 or the accessory 400 according to some embodiments comprising light emitting elements 110 for emitting light within the ultraviolet spectrum may also be used for stimulating the human skin to produce vitamin D. This may be an advantage in particular for people suffering from vitamin D deficiency or jaundice. Also, the portable electronic device 100 or the accessory 400 may be used for treating certain skin conditions such as psoriasis, vitiligo or acne.

The portable electronic device 100 or the accessory 400 according to some embodiments comprising light emitting elements 110 for emitting light within the ultraviolet spectrum may also be used for sun tanning.

The portable electronic device 100 or the accessory 400 according to some embodiments comprising light emitting elements 110 for emitting light within the ultraviolet spectrum may also be used for finding cracks, repaired damages, repainted surfaces, etc, as such damages are easy to spot in ultraviolet light. This may be an advantage, for example, when buying antiques, etc.

The portable electronic device 100 or the accessory 400 may in some embodiments be used as a party booster, providing a consistent ultraviolet light and/or stroboscopicly blinking ultraviolet flashes, etc. In some embodiments, a music player such as an MP3 player may be included within the portable electronic device 100 or in the portable communication device 500 or even within the accessory 400, and activated simultaneously with the generation of the light 120 outside the visible spectrum when the portable electronic device 100 or the accessory 400 is set into party booster mode.

The recreational effect of the described portable electronic device 100 or the accessory 400 may be somewhat increased, for example, by using fluorescent makeup in combination with the invention.

While the portable electronic device 100, the method for visualization of an object 130 in darkness, the computer program and the accessory 400 described in this document is susceptible to various modifications and alternative forms, specific embodiments thereof are shown by way of example in the drawings and are herein described in detail. It should be understood, however, that there is no intent to limit the present portable electronic device 100, the method for visualization of an object 130 in darkness, computer program or accessory 400 to any of the particular forms disclosed, but on the contrary, the present portable electronic device 100 and method, computer program and accessory 400 is to cover all modifications, equivalents, and alternatives falling within the spirit and scope of the portable electronic device 100, the method for visualization of an object 130 in darkness, computer program and accessory 400 as defined by the claims.

Like reference numbers signify like elements throughout the description of the FIGS.

As used herein, the singular forms “a,” “an,” and “the” are intended to include the plural forms as well, unless expressly stated otherwise. It should be further understood that the terms, “comprises,” “comprising,” “includes,” and/or “including” when used in the specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present.

Furthermore, “connected” or “coupled” as used herein may include wirelessly connected or coupled. As used herein, the term “and/or” includes any and all combinations of one or more of the associated listed items.

Unless otherwise defined, all terms including technical and scientific terms used herein have the same meaning as commonly understood by one of ordinary skill in the art to which the portable electronic device 100, the method for visualization of an object 130 in darkness, computer program and/or accessory 400 belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A portable electronic device comprising:
an image capturing unit adapted to capture at least one image of an object; and
at least one light emitting element, wherein the at least one light emitting element is adapted to emit light with a wavelength outside the visible spectrum, and the image capturing unit is adapted to capture an image of the object illuminated with light with a wavelength outside the visible spectrum.

2. The portable electronic device of claim 1, wherein the portable electronic device comprises a control unit, the control unit being adapted to activate the at least one light emitting element when the portable electronic device is set in an image capturing mode.

3. The portable electronic device of claim 2, wherein the portable device comprises a communication unit adapted to establish a video telephony connection with a recipient of a video telephony call, and the control unit is adapted to activate the at least one light emitting element continuously, as long as the portable electronic device is set in an image capturing mode.

4. The portable electronic device of claim 2, wherein the portable electronic device comprises a light sensor, adapted to measure light related data indicating the strength of the incoming light, and at least one light emitting element adapted to receive a control signal from the control unit, wherein the control unit is adapted to receive light related data indicating the strength of the incoming light and comparing it with a predetermined threshold value, and to determine when to activate and when to deactivate the at least one light emitting element based on said light related data, and to send control information to the at least one light emitting element for activating or deactivating the at least one light emitting element.

5. The portable electronic device of claim 4, wherein the control unit is adapted to determine the strength of the light that the at least one light emitting element has to emit in order to enlighten an object based on said light related data, and to send control information to the at least one light emitting element for adjusting the strength of the light emitted from the at least one light emitting element.

6. The portable electronic device of claim 1, wherein the portable electronic device comprises a viewfinder, adapted to display the object illuminated by the at least one light emitting element.

7. The portable electronic device of claim 1, wherein the portable electronic device comprises a lens situated in front of at least one of the at least one light emitting elements.

8. The portable electronic device of claim 7, wherein the lens is adapted to focus the emitted light on a distance of about 0.2 to about 0.5 meters.

9. The portable electronic device of claim 1, wherein at least one light emitting element is adapted to emit infrared light, with a wavelength of about 750 nm to about 1 mm.

10. The portable electronic device of claim 1, wherein at least one light emitting element is adapted to emit ultraviolet light with a wavelength of about 10 nm to about 400 nm.

11. The portable electronic device of claim 1, wherein the portable electronic device is represented by a portable communication device such as a mobile cellular radiotelephone.

12. A method for visualization of an object in darkness by using a portable electronic device including an image capturing unit and at least one light emitting element, the method comprising:
activating an image capturing function;
receiving a darkness indication; and
emitting light with a wavelength outside the visible spectrum, wherein the intended photo object is illuminated with the light, if a darkness indication is received and an image capturing function is activated.

13. The method of claim 12, further comprising:
measuring light related data, indicating the strength of the incoming light;
comparing the measured light related data with a predetermined threshold value;
determining when to activate and when to deactivate the at least one light emitting element based on said light related data;
generating control information, for activating or deactivating the at least one light emitting element; and
sending the generated control information to the at least one light emitting element for activating the at least one light emitting element if the measured light related data is lower than a certain predetermined threshold value, or deactivating the at least one light emitting element if the measured light related data is higher than a certain predetermined threshold value and the image capturing unit are still activated.

14. A computer program product comprising computer-readable program code embodied on a computer-readable medium, the computer readable program code being configured to carry out the method of claim 12.

15. An accessory arranged to be attached to a portable electronic device which includes an image capturing unit, the accessory comprising:
a connection unit adapted to send and/or receive control signals from the portable electronic device, and
at least one light emitting element adapted to emit light with a wavelength outside the visible spectrum if a darkness indication is received and the portable electronic device is set in an image capture mode.

16. The accessory of claim 15 arranged to be attached to a portable electronic device, wherein the accessory comprises:
a light sensor, adapted to measure light related data indicating the strength of the incoming light, said light sensor, being further adapted to send said light related data to a control unit, and
at least one light emitting element adapted to receive a control signal from the control unit, wherein: the control unit is adapted to determine when to activate and when to deactivate the at least one light emitting element based on said light related data, and to send control information to the at least one light emitting element for activating or deactivating the at least one light emitting element.

17. The accessory of claim 15, wherein the accessory comprises a lens situated in front of at least one of the at least one light emitting element.

18. The accessory of claim 15, wherein the lens is adapted to focus the emitted light on a distance of approximately 0.2-0.5 meters.

19. An accessory according to claim 15, wherein the at least one light emitting element is adapted to emit infrared light, with a wavelength between 750 nm and 1 mm.

20. The accessory of claim 15, wherein the at least one light emitting element is adapted to emit ultraviolet light with a wavelength of about 10 nm to about 400 nm.

21. The accessory of claim 15, wherein the accessory is configured to be attached to a portable communication device such as a mobile cellular radiotelephone.
